(19) United States
(12) Patent Application Publication
(10) Pub. No.: US 2022/0017047 A1
(43) Pub. Date: Jan. 20, 2022

(54) Sensor Cleaning System for Vehicles

(71) Applicant: Joma-Polytec GmbH, Bodelshausen (DE)

(72) Inventors: Thomas Gulde, Hechingen (DE); Christian Scheibe, Rottenburg am Neckar (DE); Ralph Bühler, Grosselfingen (DE)

(73) Assignee: Joma-Polytec GmbH, Bodelshausen (DE)

(21) Appl. No.: 17/023,466

(22) Filed: Sep. 17, 2020

(30) Foreign Application Priority Data
Sep. 26, 2019 (DE) 10 2019 125 970.3

(51) Int. Cl. B60S 1/48; B60S 1/54; B60S 1/56; B60S 1/50

(52) U.S. Cl. CPC B60S 1/481; B60S 1/54; B60S 1/50; B60S 1/487; B60S 1/56

(57) ABSTRACT

Sensor cleaning system for cleaning sensors, in particular vehicle sensors, and associated method, characterized by a liquid reservoir for holding a cleaning liquid, and including a control unit for activating a switch unit and including at least one nozzle for spraying at least one sensor, the switch unit being provided between the liquid reservoir and the at least one nozzle, a liquid line being provided between the liquid reservoir and the switch unit and at least one nozzle line being provided between the switch unit and the at least one nozzle.

### BACKGROUND OF THE INVENTION

The invention relates to a sensor cleaning system which is used in particular in the field of vehicles. Such a sensor cleaning system comprises a liquid reservoir for holding a cleaning liquid, a control unit for activating a switch unit and at least one nozzle for spraying at least one sensor, the switch unit being provided between the liquid reservoir and the at least one nozzle, a fluid line being provided between the liquid reservoir and the switch unit and at least one nozzle line being provided between the switch unit and the at least one nozzle. A cleaning liquid, which is supplied in the liquid reservoir, is used to spray the sensors. The control unit controls the switch unit during operation such that a fluidic connection is established between the liquid reservoir and the nozzle. The cleaning liquid is delivered through the liquid line and the nozzle line and leaves the nozzle so as to spray the sensor. Ultimately, the surface of the sensors is cleaned by spraying with the cleaning liquid.

Sensor cleaning systems of this kind are known from DE 10 2018 106 483 A1.

The cleaning of sensors, in particular in the vehicle environment, is necessary because the sensors are exposed to external influences such as dirt, oils, mud, snow, etc., in particular during vehicle operation. When using sensors in vehicles that are controlled autonomously, for example, the reliability of the sensors is of vital importance. This is determined, among other things, by the cleanliness of the surface of the sensor. It must therefore be ensured, in particular for safe, autonomous driving, that contaminants, in particular strongly adhering contaminants, on the sensor can be reliably cleaned by a sensor cleaning system. In addition, the use of the sensor cleaning system should be considered from an ecological and economic point of view. A sufficient amount of cleaning liquid is necessary to restore the sensors to an adequate level of cleanliness. The less cleaning liquid is used, the more economically the sensor cleaning system can be operated and the lower the negative impact on the environment.

### SUMMARY OF THE INVENTION

The aim of the invention is that of providing a sensor cleaning system by means of which reliable cleaning of the sensors can be achieved, in particular using as little cleaning liquid as possible.

This aim is achieved by a sensor cleaning system. In particular, therefore, a gas reservoir fluidically connected to the liquid reservoir is provided for holding a cleaning gas, and a gas line is provided between the gas reservoir and the switch unit. The cleaning liquid and the cleaning gas are pressurized during operation such that the cleaning liquid and/or the cleaning gas can be delivered toward the particular nozzle and thus toward the particular sensor. The switch unit is designed in such a way that the at least one sensor can be cleaned via the at least one nozzle line by means of the cleaning liquid leaving the at least one nozzle and/or the cleaning gas leaving the at least one nozzle. The surface of the sensors can therefore be sprayed by cleaning liquid, cleaning gas and/or a mixture of the cleaning liquid and the cleaning gas, and thus cleaned. Due to the pressurization of the cleaning liquid and the cleaning gas, an active pump is not absolutely necessary for the delivery. The control unit controls the switch unit in particular such that a fluidic connection is established between the liquid reservoir and/or the gas reservoir and the nozzle, so that, depending on the type and degree of contamination, the sensors are sprayed with the appropriate fluid, i.e. with cleaning liquid, cleaning gas or a mixture thereof. A large number of sensors on the vehicle can be cleaned, a nozzle and an associated nozzle line being provided for each sensor for cleaning.

As a result, targeted use of the cleaning liquid and the cleaning gas for cleaning the sensors is possible. In addition, providing the pressurized cleaning liquid and the pressurized cleaning gas allows the cleaning pressure to be available more quickly than is the case for delivery mechanisms by pure pumping. A high level of reliability of the system is based on the fact that the pressurized cleaning liquid and the pressurized cleaning gas mean that the system can work without supplied energy and that the system does not fail even if there is a drop in energy, for example when the vehicle batteries are empty. It is still possible to clean the sensors even if the pump fails. The targeted use of cleaning liquid and/or cleaning gas makes economical use of the fluids possible. In the case of more strongly adhering contaminants, e.g. oils, the sensor can be sprayed with the cleaning liquid. In the case of moderately adhering contaminants, e.g. mud, a mixture of the cleaning liquid and the cleaning gas can be used. In the case of lightly adhering contaminants, e.g. dust and snow, and for drying, the cleaning gas can be used to spray the sensors.

The control unit advantageously controls the duration of the switch positions so that a sensor can be cleaned alternately by means of the cleaning liquid and the cleaning gas and/or pulsatingly by means of the cleaning liquid and/or the cleaning gas. When cleaning a sensor alternately, the sensor is first sprayed with a cleaning liquid and then with a cleaning gas, for example. The two fluids can spray the sensor one directly after the other, or a waiting time can be provided during the changeover. Alternatively, a cleaning liquid and a mixture of the cleaning liquid and the cleaning gas can be used, for example, in the case of alternating cleaning. Another alternative for cleaning the sensors is to first use cleaning gas and then the cleaning liquid. In this case, the cleanliness of the sensors to be cleaned can advantageously be checked after the first interval of cleaning using the cleaning gas. If a sufficient level of cleanliness has already been achieved, the subsequent interval of cleaning by means of the cleaning liquid and thus consumption of the cleaning liquid can be dispensed with. In the case of pulsating cleaning, for example, the cleaning liquid is delivered for a duration of one pulse and then the delivery is stopped again. This process can be repeated several times so that in particular high frequencies can be set. This is possible owing to the cleaning pressure being quickly available.

Both with the alternating and the pulsating method, different interval durations are possible when cleaning by means of the different fluids. An interval of alternating cleaning can be followed by an interval of pulsating cleaning and vice versa.

A compressed gas source controlled by the control unit can advantageously be used to provide the compressed cleaning gas in the gas reservoir. For example, a high-pressure pump such as that used in vehicles for air suspension or level control can be used. Consequently, in order to use the sensor cleaning system, no additional pump is necessary as a delivery unit. In addition, a small, low-performance, and therefore energy-saving, pump can be used to compress the cleaning gas, since the gas reservoir does not have to be filled immediately.

It is advantageous if the gas reservoir is filled in accordance with the operating state of the vehicle. Consequently, the control unit can then be designed in such a way that the compressed gas source is operated in phases of energy surplus and/or noisy phases in order to compress the cleaning gas. An energy surplus can be achieved, for example, in electrically powered vehicles when driving downhill. Noisier phases of driving operation can include, for example, starting off, driving uphill or acceleration phases. In these cases, the pressurization of the cleaning gas would not be perceptible to the vehicle occupants, since free capacities are used, and the operation of the pump is masked by typical driving noises.

In one embodiment, the gas reservoir is arranged in one container and the liquid reservoir is arranged in another container. A reservoir line, via which the two containers are interconnected, is arranged between the two containers. An additional switch unit between the containers is advantageous here. It is then easier to fill in the cleaning liquid in a pressure-free manner, since only the switch unit between the gas reservoir and the liquid reservoir has to be closed.

A more compact embodiment of the sensor cleaning system can be achieved by accommodating the cleaning liquid and the cleaning gas in a common container. The cleaning liquid and the cleaning gas are directly adjacent to one another. When the cleaning gas located above the cleaning liquid is compressed, the cleaning liquid is simultaneously pressurized by means of the cleaning gas, so that ultimately the cleaning liquid and also the cleaning gas are present in a pressurized state. A switch unit between the liquid reservoir and the gas reservoir can then be dispensed with. However, the container must then be vented beforehand in order to fill in the cleaning liquid in a pressure-free manner.

It is also advantageous if a connection for filling in the cleaning liquid and a connection for filling in the cleaning gas or a common connection for filling in the cleaning liquid and the cleaning gas are provided in the container. A filling level sensor, a quality sensor and/or a pressure sensor can also be provided in the container. The control unit is then designed in such a way that the filling level of the cleaning liquid in the container is monitored by means of the filling level sensor. If the filling level of the cleaning liquid falls below a lower limit value, the filling of the container with cleaning liquid is requested or initiated. The quality sensor can be used to monitor the cleaning liquid in terms of mixing ratio, degree of contamination, purity, etc. The cleaning liquid can be water-based and mixed with additives, for example cleaning agents and antifreeze agents. The cleaning gas can be air, for example. In addition, the control unit is preferably designed such that the pressure in the container can be monitored by means of the pressure sensor. If an upper limit value is exceeded, the container can be vented via a vent valve so that a suitable pressure is established. If the value falls below a lower limit value, the cleaning gas in the reservoir can be compressed in the next suitable phase.

It is also advantageous if a heat exchanger is provided at the container or in the lines of the sensor cleaning system. The heat exchangers can be operated electrically and/or using heat from a cooling circuit. When using the heat from the cooling circuit, free capacities are used. By operating heat exchangers in the system, freezing of the cleaning liquid can be prevented and, in addition, more favorable flow conditions for the cleaning liquid and cleaning gas can be achieved during delivery and when spraying the sensor.

The switch unit advantageously comprises switch valves that can be controlled by the control unit. The switch valves can be switched to different switch positions. In one switch position, all switch valves are in the closed position, so that cleaning liquid and/or cleaning gas cannot be delivered. The sensor cleaning system, for example, would be in this switch position if no cleaning is to be carried out. A further switch position allows the cleaning liquid to be delivered by the switch valve associated with the liquid reservoir establishing a fluidic connection between the liquid line and the nozzle line. The sensor to be cleaned is thus sprayed with the cleaning liquid. Another switch position is used to deliver the cleaning gas. In this switch position there is a fluidic connection between the gas line and the nozzle line. In another switch position, there is a fluidic connection between the liquid line and the nozzle line as well as between the gas line and the nozzle line, so that the sensor to be cleaned is sprayed with a mixture of the cleaning liquid and the cleaning gas. The selection of the suitable fluid for cleaning the sensor can be made, for example, depending on the type of contamination and the degree of contamination. The control unit is designed in such a way that the volume flow of the fluids and the mixing ratio of the mixture of cleaning liquid and cleaning gas can be controlled by the open cross section of the switch valves.

To operate the sensor cleaning system by means of purely alternating spraying of the sensors, an upstream 2/2-way valve having the liquid line and the gas line as an inlet can be provided, and a 2/2-way valve having the nozzle line as an outlet can be provided for each nozzle. Alternatively, the switch unit can have, for each nozzle, a 3/2-way valve having the liquid line and the gas line as the inlet and having the nozzle line as the outlet.

For alternating and pulsating spraying of the sensor with the cleaning liquid and/or the cleaning gas, two 2/2-way valves, each having the liquid line or the gas line as the inlet and the nozzle line as the outlet, can be provided for each nozzle. When both 2/2-way valves of a nozzle are opened at the same time, the cleaning liquid and the cleaning gas mix in the region of the nozzle, so that the sensor can be sprayed with a mixture of the cleaning liquid and the cleaning gas.

It is also advantageous if the control unit is designed in such a way that the sensors can be cleaned at defined time intervals depending on the time of year, the weather and the vehicle location and/or based on a cleaning signal from the sensors to be cleaned and/or a dirt sensor on the sensor. It can thus be ensured that the sensors have a suitable level of cleanliness and highly reliable data acquisition by the sensors is possible.

It is also advantageous if the sensors to be cleaned determine their own degree of contamination, or if dirt sensors are provided by means of which a degree of contamination of the sensors to be cleaned can be determined. Depending on the degree of contamination detected, the sensors can then be cleaned in an automated manner by means of the sensor cleaning system.

The aim set out at the outset is also achieved by a method for cleaning sensors by spraying a sensor with cleaning liquid and/or cleaning gas, comprising the following method steps:

a. providing pressurized cleaning liquid in a liquid reservoir;

b. providing compressed cleaning gas in a gas reservoir; and

c1. alternately spraying the sensor with the cleaning liquid and the cleaning gas;

and/or

c2. pulsatingly spraying the sensors with the cleaning liquid and/or the cleaning gas.

Consequently, in method step a., a cleaning liquid is pressurized in a liquid reservoir. Furthermore, the method comprises a method step b., in which a compressed cleaning gas is supplied in a gas reservoir. The further method steps c1. and c2. can be used alternatively or alternately. In method step c1., the sensor is sprayed alternately with the cleaning liquid and the cleaning gas. A waiting time can be provided during the changeover of the fluids or the two fluids can be alternated immediately one after the other. In method step c2., the sensors are pulsatingly sprayed with the cleaning liquid and/or cleaning gas. Consequently, the sensor to be cleaned can be sprayed with the cleaning liquid and/or the cleaning gas in a pulsed operation. A high pulse frequency can advantageously be set, at which more strongly adhering contaminants can be cleaned.

It is also advantageous that the cleaning gas according to method step b. can be compressed in accordance with the operating state of the vehicle and/or of the sensor cleaning system and/or the cleanliness of the sensors. Free capacities of the vehicle can thus be used to compress the cleaning gas and the sound emission of the pump can be masked by driving noises. In addition, for example, the cleaning gas can be compressed in order to prepare for intensive use due to an expected high degree of contamination.

The aim mentioned at the outset is also achieved by using a sensor system according to the invention for carrying out the method according to the invention.

Further details and advantageous embodiments of the invention can be found in the following description, on the basis of which an embodiment of the invention shown in the drawings is described and explained in more detail.

### BRIEF DESCRIPTION OF THE DRAWINGS

In the drawings:

FIG. 1 is a schematic representation of the sensor cleaning system comprising the sensors to be cleaned;

FIG. 2 is a schematic representation of an alternative embodiment of the liquid reservoir and the gas reservoir;

FIG. 3a is a schematic representation of an alternative embodiment of the switch unit; and

FIG. 3b is a schematic representation of a further alternative embodiment of the switch unit.

### DETAILED DESCRIPTION

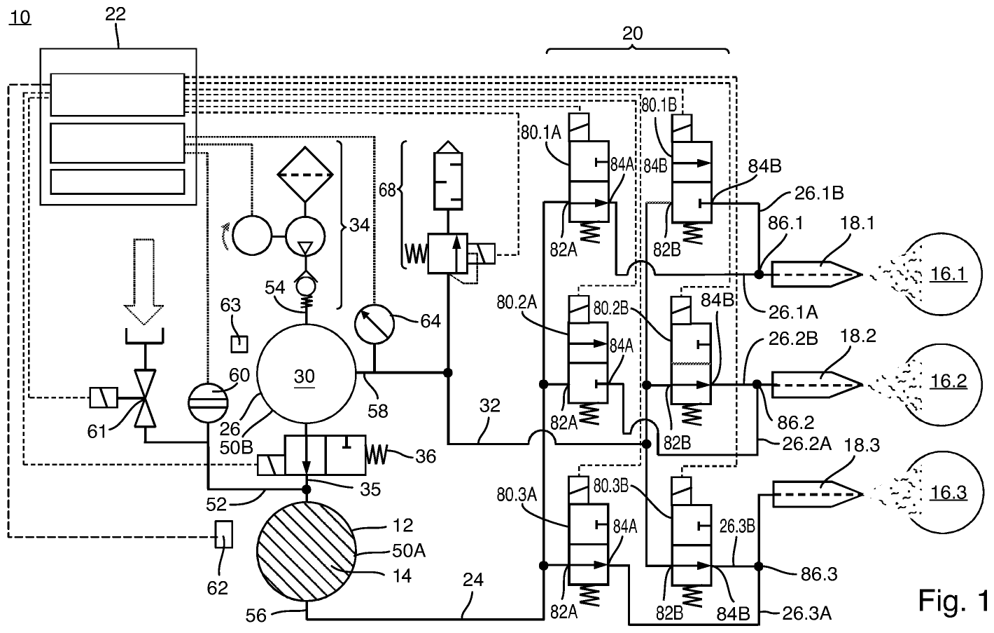

The sensor cleaning system 10 shown in FIG. 1 for cleaning three sensors 16.1, 16.2, 16.3 shown in FIG. 1 comprises a liquid reservoir 12 for holding a cleaning liquid 14, a gas reservoir 28 for holding a cleaning gas 30, a switch unit 20, a control unit 22 for controlling the switch unit 20 and three nozzles 18.1, 18.2, 18.3 for cleaning the respective sensors 16.1, 16.2, 16.3. The liquid reservoir 12 is arranged in a liquid container 50A and the gas reservoir 28 is arranged in a gas container 50B.

An inlet 52 for filling in the cleaning liquid 14 and an outlet 56 for delivering the cleaning liquid 14 are provided at the liquid container 50A. A filling level sensor 60 and a switch valve 61 are provided at the inlet 52 such that the cleaning liquid 14 can be filled in manually or in an automated manner. The switch valve 61 can be controlled by the control unit 22. The output signals from the filling level sensor 60 are supplied to the control unit 22 to form a control loop.

An inlet 54 for filling in the cleaning gas 30 and an outlet 58 for delivering the cleaning gas 30 are provided at the gas container 50B. A compressed air pump 34 for compressing the cleaning gas 30 is provided at the inlet 54, and a pressure sensor 64 and a pressure-relief valve 68 are provided at the outlet 58. A quality sensor 62 is arranged at the liquid container 50A and a quality sensor 63 is arranged at the gas container 50B. The compressed air pump 34 is activated by the control unit 22; the output signals from the quality sensor 62 and from the pressure sensor 64 are communicated to the control unit 22 to form control loops.

A reservoir line 35 and a valve unit 36 are arranged between the liquid container 50A and the gas container 50B. The valve unit 36 can be switched to a switch position by the control unit 22 so that a fluidic connection can be established between the liquid reservoir 12 and the gas reservoir 28.

A liquid line 24 is arranged between the liquid container 50A and the switch unit 20 and a gas line 32 is arranged between the gas container 50B and the switch unit 20. The liquid line 24 is attached to the outlet 56 of the liquid container 50A and the gas line 32 is attached to the outlet 58 of the gas container 50B.

The control unit 22 controls the compressed air source 34 connected to the gas reservoir 28 such that the gas reservoir 28 is filled with the cleaning gas 30 in accordance with the operating state of the vehicle.

When the fluidic connection between the liquid reservoir 12 and the gas reservoir 28 is established via the reservoir line 35, both the cleaning liquid 14 and the cleaning gas 30 are supplied under excess pressure, i.e. pressurized, by the compressed cleaning gas 30 in the gas reservoir 28. The excess pressure allows the cleaning liquid 14 and the cleaning gas 30 to be delivered. The switch unit 20 is designed such that the sensors 16.1, 16.2, 16.3 to be cleaned can be cleaned by means of cleaning liquid 14 and/or cleaning gas 30 leaving the nozzles 18.1, 18.2, 18.3.

During operation, the cleaning gas 30 can be supplied in the gas container 50B under excess pressure by the activation of the air pressure source 34. The cleaning liquid 14 can be filled into the liquid container 50A via the inlet 52. By blocking the fluidic connection via the reservoir line 35 by switching the valve unit 36, it is possible to fill the cleaning liquid 14 into the fluid container 50A via the inlet 52 in a pressure-free manner.

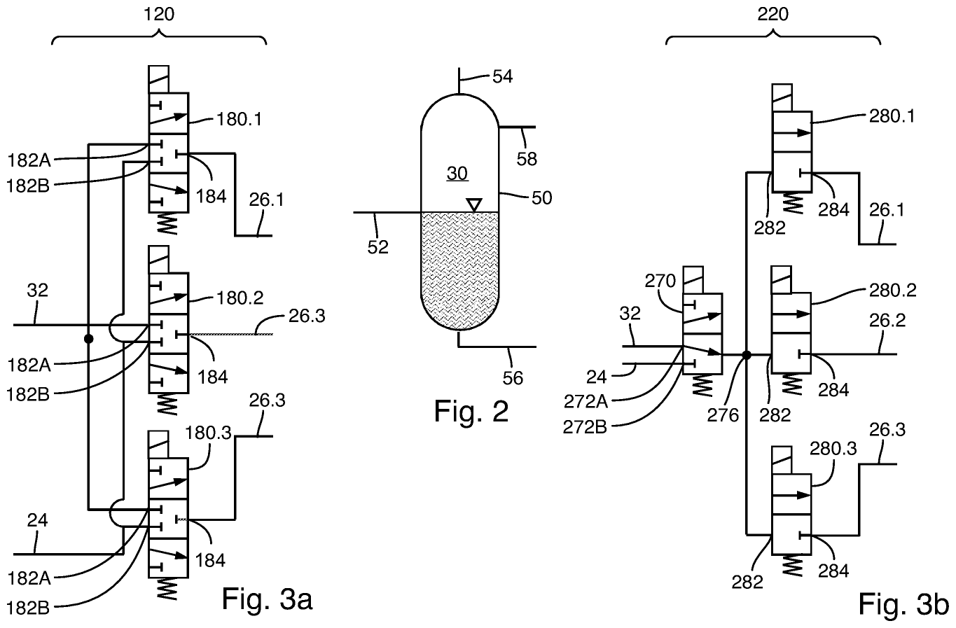

FIG. 2 shows an alternative embodiment of the liquid reservoir 12 and the gas reservoir 28. In said figure, the cleaning liquid 14 and the cleaning gas 30 are supplied in a common container 50 so as to be adjacent to one another. The container 50 comprises an inlet 52 as a connection for filling in the cleaning liquid 14 and an inlet 54 as a connection for the compressed air source 34. Furthermore, an outlet 56 for connecting the liquid line 24 and an outlet 58 for connecting the gas line 32 are provided.

As is clear from FIG. 1, two nozzle lines 26.1A, 26.1B, 26.2A, 26.2B, 26.3A, 26.3B are arranged between the switch unit 20 and the three nozzles 18.1, 18.2, 18.3, which nozzle lines merge at the particular junction 86.1, 86.2, 86.3 and lead into the respective nozzles 18.1, 18.2, 18.3. The switch unit 20 can be switched by the control unit 22 such that a fluidic connection can be established between the liquid reservoir 12 or the gas reservoir 28 and the nozzles 18.1, 18.2, 18.3.

The switch unit 20 can be controlled to various switch positions by the control unit 22. The cleaning mode for cleaning the sensors 16.1, 16.2, 16.3 is set by controlling the switch position and its duration. The sensors 16.1, 16.2, 16.3 to be cleaned can thus be sprayed alternately with the cleaning liquid 14 and the cleaning gas 30 and/or pulsatingly with the cleaning liquid 14 and/or the cleaning gas 30.

A heat exchanger 66, which is in particular operated electrically and/or using heat from a cooling circuit, can be provided at each of the containers 50, 50A, 50B.

Various embodiments of the switch units 20, 120, 220 are shown in FIGS. 1, 3 and 4. The switch units 20, 120, 220 comprise switch valves 80.1A, 80.1B, 80.2A, 80.2B, 80.3A, 80.3B, 180.1, 180.2, 180.3, 270, 280.1, 280.2, 280.3, which can be switched to different positions. One switch position acts as a closed position and disconnects the fluidic connection between the liquid reservoir 12 and the nozzles 18.1, 18.2, 18.3 and between the gas reservoir 28 and said nozzles. A further switch position is used to deliver the cleaning liquid 14 by a fluidic connection being established between the liquid reservoir 12 and the nozzle 18. A further switch position is used to deliver the cleaning gas 30. A final switch position is used to deliver a mixture of cleaning liquid 14 and cleaning gas 30.

The switch unit 20 of FIG. 1 comprises, for each nozzle 18.1, 18.2, 18.3, a 2/2-way valve 80.1A, 80.2A, 80.3A for the cleaning liquid 14 and a 2/2-way valve 80.1B, 80.2B, 80.3B for the cleaning gas 30. An inlet 82A for the liquid line 24 and an outlet 84A for the nozzle line 26 are provided at each of the 2/2-way valves 80.1A, 80.2A, 80.3A. An inlet 82B for the gas line 32 and an outlet 84B for nozzle line 26 are provided at the 2/2-way valves 80.1B, 80.2B, 80.3B. Each of the nozzle lines 26.1A, 26.1B; 26.2A, 26.2B; 26.3A, 26.3B of the cleaning liquid 14 and of the cleaning gas 28 join together at a junction 86 and there lead to the respective nozzles 18.1, 18.2, 18.3.

The two 2/2-way valves 80.1A, 80.1B are shown in a position such that the sensor 16.1 is sprayed only with cleaning liquid 14. For this purpose, the 2/2-way valve 80.1A is in the open position and the 2/2-way valve 80.1B is in the closed position. In this case, a fluidic connection is established between the liquid reservoir 12 and the nozzle 18.1, whereas there is no fluidic connection between the gas reservoir 28 and the nozzle 18.1 via the nozzle line 26.1B.

The two 2/2-way valves 80.2A, 80.2B are shown in a position such that the sensor 16.2 is sprayed only with cleaning gas 30. For this purpose, the 2/2-way valve 80.2A is in the closed position and the 2/2-way valve 80.2B is in the open position. In this case, a fluidic connection is established between the gas reservoir 28 and the nozzle 18.1, whereas there is no fluidic connection between the liquid reservoir 12 and the nozzle 18.1 via the nozzle line 26.1A.

The two 2/2-way valves 80.3A, 80.3B are shown in a position such that the sensor 16.3 is sprayed with cleaning liquid 14 and cleaning gas 30. For this purpose, the 2/2-way valves 80.3A, 80.3B are in the open position. In this case, a fluidic connection is established between the liquid reservoir 12 and the nozzle 18.3 and between the gas reservoir 28 and said nozzle via the nozzle lines 26.3A, 26.3B.

The switch unit 120 according to FIG. 3a comprises, for each nozzle 18.1, 18.2, 18.3, a 3/2-way valve 180.1, 180.2, 180.3 which can be switched to three positions. An inlet 182A for the liquid line 24 and an inlet 182B for the gas line 32 and an outlet 184 for the nozzle line 26 are provided at each of the 3/2-way valves 180.1, 180.2, 180.3. A sensor cleaning system 10 comprising the switch unit 120 allows the respective sensors 16.1, 16.2, 16.3 to be cleaned by means of the cleaning liquid 14 or the cleaning gas 30.

The switch unit 220 according to FIG. 3b comprises an upstream 2/2-way valve 270 comprising an inlet 272A for the liquid line 24 and an inlet 272B for the gas line 32 and an outlet 274 to the junction 276, which establishes the fluidic connection to the downstream 2/2-way valves 280.1, 280.2, 280.3. The 2/2-way valves 280.1, 280.2, 280.3 each comprise an inlet 282 for connecting the line coming from the junction 276 and an outlet 284 for the nozzle lines 26.1, 26.2, 26.3. A sensor cleaning system 10 comprising the switch unit 220 allows the sensors 16.1, 16.2, 16.3 to be cleaned by means of the cleaning liquid 14 or the cleaning gas 30.

According to the invention, further switch units (not shown) having any arrangement of switch valves are conceivable. It is crucial that the liquid line 24 and the gas line 32 each lead into the switch valves, or the switch valves can be switched to positions by the control unit 22, such that the sensors 16.1, 16.2, 16.3 can be cleaned via the nozzle line 26 by means of the cleaning liquid 14 leaving the at least one nozzle 18 and/or the cleaning gas 30 leaving the at least one nozzle 18.

The control unit 22 is in particular designed such that the sensors 16.1, 16.2, 16.3 are cleaned at defined time intervals depending on the time of year, the weather and the vehicle location and/or based on a cleaning signal from the sensors 16.1, 16.2, 16.3 to be cleaned and/or a dirt sensor 70 on the sensors 16.1, 16.2, 16.3. It is also advantageous if the sensors 16.1, 16.2, 16.3 to be cleaned determine their own contamination condition. Of course, it is also conceivable for dirt sensors to be provided, by means of which the particular degree of contamination of the sensors 16.1, 16.2, 16.3 to be cleaned can be determined. Depending on the degree of contamination detected, the sensors 16.1, 16.2, 16.3 can then be cleaned in an automated manner by means of the sensor cleaning system 10.

1. Sensor cleaning system for cleaning sensors, comprising a liquid reservoir for holding a cleaning liquid, comprising a control unit for activating a switch unit and comprising at least one nozzle for spraying at least one sensor, the switch unit being provided between the liquid reservoir and the at least one nozzle,
a liquid line being provided between the liquid reservoir and the switch unit and at least one nozzle line being provided between the switch unit and the at least one nozzle, characterized in that a gas reservoir fluidically connected to the liquid reservoir is provided for holding a cleaning gas,
in that a gas line is provided between the gas reservoir and the switch unit,
in that the cleaning liquid and the cleaning gas are pressurized during operation such that the cleaning liquid and/or the cleaning gas can be delivered toward the particular nozzle, and
in that the switch unit is designed such that the at least one sensor can be cleaned via the at least one nozzle line by means of the cleaning liquid leaving the at least one nozzle and/or by means of the cleaning gas leaving the at least one nozzle.

2. Sensor cleaning system according to claim 1, characterized in that the switch unit can be controlled to switch positions by the control unit such that the at least one sensor can be sprayed over the duration of the switch position alternately with the cleaning liquid and the cleaning gas and/or pulsatingly with the cleaning liquid and/or the cleaning gas.

3. Sensor cleaning system according to claim 1, characterized in that a compressed gas source controlled by the control unit is provided for compressing the cleaning gas in the gas reservoir.

4. Sensor cleaning system according to claim 3, characterized in that the control unit controls the compressed gas source such that the gas reservoir is filled in accordance with the operating state of the vehicle.

5. Sensor cleaning system according to claim 1, characterized in that a common container is provided for holding the cleaning liquid and the cleaning gas.

6. Sensor cleaning system according to claim 5, characterized in that the container has an inlet for filling in the cleaning liquid and an inlet for filling in the cleaning gas or a common inlet for filling in the cleaning liquid and the cleaning gas as well as a filling level sensor, a quality sensor and/or a pressure sensor.

7. Sensor cleaning system according to claim 5, characterized in that a heat exchanger, which is operated electrically and/or using heat from a cooling circuit, is provided at the container.

8. Sensor cleaning system according to claim 1, characterized in that the switch unit comprises switch valves which can be controlled by the control unit, the switch valves being switchable to different switch positions, one switch position being provided as the closed position of the liquid reservoir and of the gas reservoir one switch position being provided for delivering the cleaning liquid, one switch position being provided for delivering the cleaning gas and one switch position being provided for delivering a mixture of cleaning liquid and cleaning gas.

9. Sensor cleaning system according to claim 1, characterized in that the control unit is designed such that the sensors can be cleaned at defined time intervals depending on the time of year, the weather and the vehicle location and/or based on a cleaning signal from the sensors to be cleaned and/or a dirt sensor on the sensor.

10. Method for cleaning sensors by spraying a sensor, characterized by the following method steps:
a. providing pressurized cleaning liquid in a liquid reservoir;
b. providing compressed cleaning gas in a gas reservoir; and at least one of the following:
c1. alternately spraying the sensor with the cleaning liquid and the cleaning gas; and
c2. pulsatingly spraying the sensors with the cleaning liquid and/or the cleaning gas.

11. Method according to claim 10, characterized in that the cleaning gas is compressed in accordance with the operating state of the vehicle and/or of the sensor cleaning system and/or the cleanliness of the sensors.

12. (canceled)
